(19) United States
(12) Patent Application Publication
(10) Pub. No.: US 2007/0281287 A1
(43) Pub. Date: Dec. 6, 2007

(54) Systems and methods for monitoring and improving academic, training or business performance

(76) Inventor: Harold J. Marioneaux JR., Chesapeake, VA (US)

Correspondence Address: Kimberly A. Chasteen, PO Box 1243, Yorktown, VA, 23692, US

(21) Appl. No.: 11/649,613

(22) Filed: Jan. 4, 2007

Related U.S. Application Data
(60) Provisional application No. 60/756,339, filed on Jan. 5, 2006.

(51) Int. Cl. G09B 3/02

(52) U.S. Cl. 434/353

(57) ABSTRACT

A tracking and monitoring system for tracking and improving performance in academic, training and business environments which provides feedback for improvement. The system tracks performance indicators and tests those performance indicators to provide more regular feedback to, for example, a student so the student can monitor progress on up to a daily basis. The system provides guidance as to what performance indicators need additional attention and provides and overall indication as to whether performance is improving, stagnant or declining. In the preferred system, outside parties, such as academic professionals, have access to the tracked performance indicators and test scores so that a student's progress can be monitored.

### CROSS REFERENCE TO RELATED APPLICATION

The present application claims priority from U.S. Provisional Application Ser. No. 60/756,339, filed Jan. 5, 2006.

### BACKGROUND OF THE INVENTION

1. Field of the Invention

This invention relates generally to systems and methods for monitoring and improving academic, training, or business performance. In particular, the present invention relates to systems and methods for monitoring and improving academic, training, or business performance utilizing improved study techniques, key performance indicators, and performance charting.

2. Description of Related Art

Higher education institutions, retail chains, governments, and other organizations are experiencing increased customer expectations and the entry of new competitors, thus leading to increased customer choices. There is a need to meet these challenges in the higher education domain, the retail domain, the government domain, the test preparation and certification services domain, and the negotiations domain by monitoring and improving performance of those participating in or providing the services.

In particular, in the education domain, students are under increasing pressure to perform successfully, particularly with respect to earning admission to college or graduate school. One of these pressures is an increased competitiveness, with preference being given to those students with successful academic performance. Students from poor academic backgrounds and/or poor socioeconomic backgrounds are less able to compete. Changes in the demographics of learners and their need for support services have positioned a college's learner support services as a strategic competitive advantage rather than an expense. Current systems for coaching weak students and for providing monitored instruction and learner support services are labor intensive, costly, and often not implemented rapidly enough for maximum effectiveness.

In the business and government domains, current systems for monitoring and improving the performance of employees, retail associates and/or salespeople are not customized for the individual's learning needs and rely on centrally located classroom or computer based training facilities or large fixed kiosks. Additionally, current systems for monitoring and improving the performance of a business or other similar entity do not satisfactorily monitor the health of the entity and provide steps for improving such health.

One important aspect of providing effective learner or training services is maintaining a high level of monitoring in a manner which encourages improvement. Currently there are previously disclosed techniques for separately or in combination monitoring and evaluating performance data for academic and business purposes.

Other previously disclosed techniques seek to recognize the affective and emotional state of the learner and respond in an appropriate manner, modeling an expert teacher or collaborator, to keep exploration going in model based subject areas, such as science, math, engineering or technology.

While such systems address various aspects of user task performance and mood, and suggest various interventions, what is needed is a comprehensive end-to-end system, which enables users to utilize a system which monitors progress and provides encouragement to improves performance.

Therefore, a need exists for a new and improved method and system for monitoring the training, academic progress or performance of trainees, students or businesses which provides effective monitoring such that students, trainees and business improve to a level allowing success at academic, training and business activities.

These, together with other objects of the invention, along with the various features of novelty that characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated current embodiments of the invention.

### SUMMARY OF THE INVENTION

Accordingly, this invention provides methods for monitoring and improving academic, training and business performance. The method for monitoring and promoting improvement in the performance of an activity by an individual, by developing at least one key performance indicator to measure the performance of the activity. In the academic field, such a key performance indicator could be the number of pages a student reads and/or the number of hours a student spends studying. The student, trainee or business performs each of the key performance indicators and performance is tracked. At desired intervals, which can be daily, tests are taken to test the performance of the activity such that test scores are obtained following each interval. The test scores are tracked and compared to the tracked key performance indicators. Feedback is provided to the student, trainee or business such that an improvement in test scores indicates the individual is performing well and a decline in test scores indicates the individual is performing poorly. The feedback also preferably includes recommendations for improvement in the case of stagnant or declining scores. The tracked information can be in written form such that it can be provided to an advisor or supervisor for review. Preferably, the tracked information is input into a computer network such that advisors or supervisors have immediate access and can monitor the individual's progress. Examples of key performance indicators which could be used in an academic environment include: the number of hours studied in a set amount of time, the number of pages read in a set assignment, the number of paragraphs read in a set assignment, practice tests covering the pages read, performance on course examinations, quizzes and assignments, the portion of course assignments completed, the number of pages read and comprehended in a set amount of time, the number of practice tests completed set amount of time; and performance on practice standardized tests.

There has thus been outlined, rather broadly, the more important features of the invention in order that the detailed description thereof that follows may be better understood and in order that the present contribution to the art may be better appreciated.

Numerous objects, features and advantages of the present invention will be readily apparent to those of ordinary skill in the art upon a reading of the following detailed description of presently current, but nonetheless illustrative, embodiments of the present invention when taken in conjunction with the accompanying drawings. In this respect, before explaining the current embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of descriptions and should not be regarded as limiting.

As such, those skilled in this art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

The invention will be better understood and objects other than those set forth will become apparent when consideration is given to the following detailed description thereof. Such description makes reference to the annexed drawings wherein:

FIG. 1 is an exemplary page of an assessment in accordance with the principles of the present invention.

FIG. 2 is a tracking page tracking a key performance indicator of the present invention;

FIG. 3 is a tracking page tracking a key performance indicator of the present invention;

FIG. 4 is a tracking page tracking a key performance indicator of the present invention;

FIG. 5 is a tracking page tracking a key performance indicator of the present invention;

FIG. 6 is a tracking page tracking a key performance indicator of the present invention;

FIG. 7 is a tracking page tracking a key performance indicator of the present invention;

FIG. 8 is a tracking page tracking a key performance indicator of the present invention;

FIG. 9 is a tracking page tracking a key performance indicator of the present invention;

FIG. 10 is an evaluation page showing improving performance;

FIG. 11 is an evaluation page showing stagnant performance; and

FIG. 12 is an evaluation page showing declining performance.

### DETAILED DESCRIPTION OF THE PREFERRED EMBODIMENT

The following detailed description is of the best presently contemplated mode of carrying out the invention. This description is not to be taken in a limiting sense, but is made merely for the purpose of illustrating general principles of embodiments of the invention.

The present invention relates generally to systems and methods for monitoring and improving academic, training or business performance. In the particularly preferred embodiment, the present invention relates to systems and methods for monitoring and improving academic performance utilizing improved study techniques, key performance indicators, and performance charting. This invention can be utilized as a notebook or as a web-based monitoring system.

The web-based site provides the same techniques and procedures that the original notebook offers and much more. The illustrations of the web-based site are as follows:

In an illustrative, non-limiting embodiment of this invention, key performance indicators (KPI) are used to monitor a student's performance and give the student an opportunity for self-assessment and improvement. In an illustrative, non-limiting embodiment of this invention, the nine KPIs must be monitored in sequential order, which are listed in the preferred order:
1. The number of hours studied for each course;
2. The number of pages read per course assignment;
3. The number of paragraphs read per class assignment (this KPI is only used when students have limited reading ability and are unable to comprehend multiple pages);
4. Practice test performance of course reading assignments and lecture material;
5. Performance on all course examinations, quizzes, and other grades;
6. Percentage of the homework assignment completed;
7. The number of pages read and comprehended in two hours;
8. The number of practice tests taken for each course;
9. The performance on mock standardized tests (PSAT, SAT, MCAT, DAT, and others);
10. Summary page to review all KPIs at a glance (this is not a KPI);
11. Scheduling page that has twenty-four hours, seven days a week (this is not a KPI).

In an illustrative, non-limiting embodiment of this invention, students who plan to utilize the principles of this invention first log into the website and register by providing name, address, email, email of faculty member, coach, advisor, and, optionally, parent. After registration, a payment for services is taken from the university, school, or individual student via credit card or cashier's check. After payment has been received, the university, school, athletic department, student, parents, and others are assigned a password for access to the monitoring system. The monitoring system students and faculty are provided with training so that understanding of how the performance monitoring system can be efficiently utilized.

When students are introduced to the system and methods of this invention, they are informed to look at themselves as a product manager responsible for monitoring the performance of their product. They are required to make recommendations to change the performance of their product. The product is their performance in the classroom, standardized test performance, and excellent class grades.

This process promotes active participation and critical thinking skills for each student. Students learn how to manage their performance and make suggestions to improve performances. They are also held accountable for their educational performance.

The Website Process

Student:

Once the student has received a class assignment in a course, the student logs onto the performance monitoring system website. The student then inputs the data for each KPI that is being monitored for each course. Once the student inputs the data the KPI will be shown as a graph.

After entering the number of hours studied in the class and the number of pages that have been read, the student clicks on the chat room section. Once the student enters the chat room, he/she is able to access practice test questions posted by the faculty member. In the chat room students may take practice tests or discuss lecture materials, or create their own test questions for other students. Once the student takes the practice test it is tabulated and the score is entered onto the practice test KPI. If the performance of the practice test falls below 75%, an email message is sent to those parties who are interested in the performance of the student (faculty, student, advisor, coach, and parents). Those students who perform below 75% are encouraged to re-read the material and take additional tests to improve their understanding of the classroom material. When the practice test data is input and the score falls below 75%, the web-based site provides the student with a recommendation for improving his/her performance on the practice test. The recommendations are as follows:
Re-read the assignment for comprehension
Increase the number of hours used to study the material
Retake a practice test until a score of 75% is reached

The chat room also gives students an opportunity to answer any questions that might be asked of him/her by other students. The key is to demonstrate an understanding (75%) of the most recent material discussed or read in the class. Each class has access to different chat rooms so that when students enter the chat room, all discussions revolve around that specific course. The practice test score evaluates the student's understanding of the lecture material. When the student enters the data for the number of hours studied in a course, the number of pages read, and the practice test taken. If the performance on the practice test is not 75% or higher, the web-based site will do the following:

Make a Recommendation:
A. Students should read for full understanding, not casual reading. Review the assignment or re-read the assignment and take an additional practice test to assess your understanding of the lecture material. You should not move forward with other assignments until you understand the reading assignment.

Warning:
A. When a student fails to perform on the first three KPIs, an electronic message is sent to the student, parent, faculty, advisor, coach, or other interested party. The email sends a warning message that states that the student is performing at a level below 75% and improvement is needed to be successful in this class.

Interested parties, such as parents, faculty, coaches or advisors, may contact the student to get recommendations to improve performance. Email is sent out every time poor performance is documented in the data.

Faculty, Advisors, Coaches:

These individuals can review all students in their classes, advisory groups, and those student athletes that the coaching staff must monitor. When they log into the web-based site, these individuals can view each student's KPIs and/or see a summary page that shows all students' performance at a glance. The staff also receives an email message of any student who is not performing at a satisfactory level.

The summary pages for the faculty, advisors, and coaches allow each party to separately input data that gives the date of graduation of each student, the number of years taken for each student to graduate, and the graduation rates of student athletes and departmental majors.

Faculty, Students:

After a lecture, the faculty member and/or students in the class can place practice test questions in the chat room. The chat room assignments are for assessing the students' understanding of the lecture materials. Students may discuss the answers and provide peer instruction. Students may submit questions to each other to see if fellow students have the appropriate understanding.

Parents:

Parents have the ability to review only their children's performance. The students' parents receive the email from the web-based site when performance is below 75%.

Students:

When performance drops for the second time as the student continues to study and input data, an email message goes out to all concerned people. The web-based site then provides the recommendation to contact a faculty member for assistance and will recommend hiring a tutor to assist the student with his/her studies.

When the student's performance drops for a third time, an email message goes out again. The web-based site provides a final suggestion such as:
Do you want to continue in this course?
Do you want to be in this class?
Recommend dropping the course if this performance continues.

The other five KPIs are completed in the same manner.

The summary page shows all of the student's KPIs on one page. This page gives an overall summary of the progress of each student. The student and parent are able to view only the student's personal data. The faculty member can review the summary page and access all data of those students enrolled in the instructor's course. The athletic director can monitor all student athletes enrolled in the program. The summary sheet will also have a section for the coach and faculty member to enter the number of years taken to graduate, the rate of graduation for student athletes, those eligible to play based on GPA.

Time/Calendar Schedule:

The web-based site has a twenty-four hour, seven day a week schedule for students to manage their affairs. The calendar keeps a tally of the number of hours of study, social hours, hours exercising, sleep, TV watching, and working. Hours of study are automatically entered on the study hour KPI once they are entered on the calendar. The calendar gives an idea of how the student's time is utilized during a week. Using this data, the student, parent, faculty and coach can determine if the student is using his/her time efficiently enough. Using the KPI of the number of pages read or comprehended in a two-hour period is a must. The student can set goals and time periods for covering reading assignments. The student's awareness of how many pages he/she can read and comprehend in two hours allows him/her the ability to set attainable goals on how much material can be read in a certain period of time. This prevents the student from setting goals that are too great, which creates frustration. The student should work within his/her range of optimal efficiency. Keeping goals realistic and attainable are the keys to academic success.

This system maintains all data input for future use and assessment needs. The data that is input is displayed on the internet by a series of colorful graphs that monitor performance on a daily and weekly basis. The web-based site also has an odometer that regulates the level of student operation. For example, if a student is functioning at an overall 70% level, the odometer reflects 70 as the speed of the student. The odometer appears as if it is live and gently moving.

In certain embodiments, weekly performance charts are preferred because students tend to see accomplishments at the end of a given week. It is important for each student to experience the process of completing or attaining a goal. Setting and accomplishing weekly goals can give the student a sense of accomplishment. This is a magnificent way to create confidence in the student. The system and methods of this invention also force each student to think critically about ways he/she can improve his/her performance by making suggestions to improve performance.

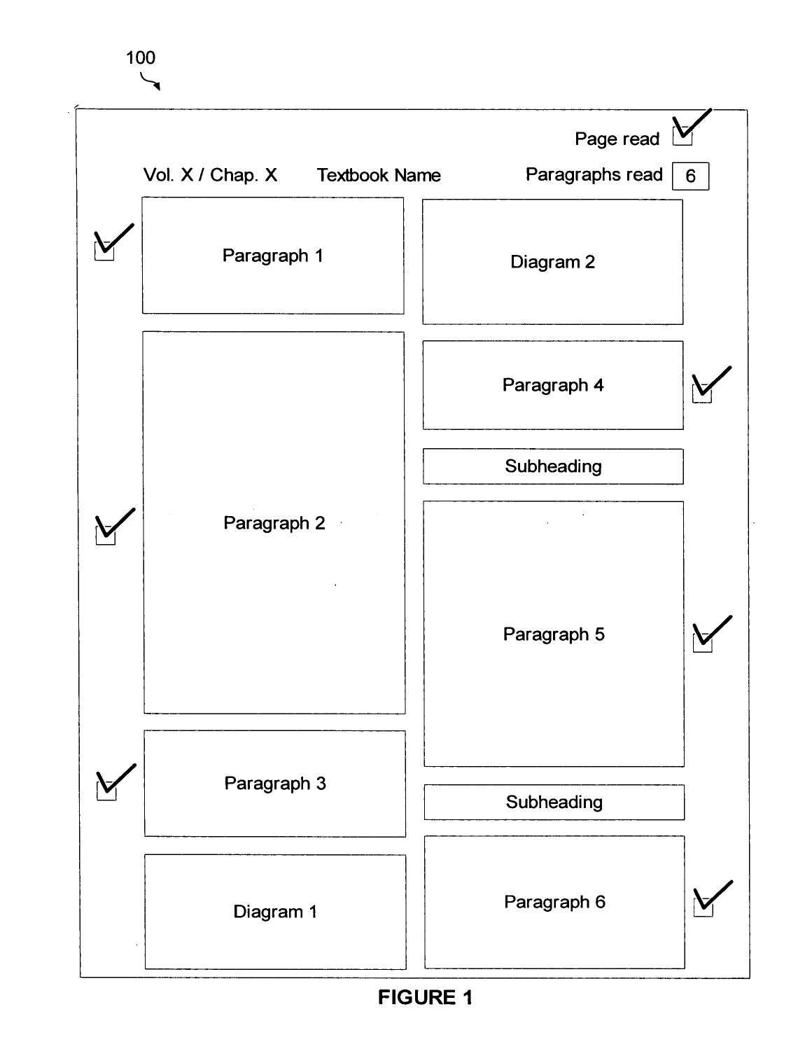

FIG. 1 shows an exemplary page of an assessment that has been divided into paragraphs according to the invention. Using the methods and systems of this invention, a given assignment of reading is initially reviewed to identify the number of pages that must be read to complete the assignment. A small box or other checkable identifier is placed on each of the assignments.

Next, each page in the assignment is divided into paragraphs. A box or checkable identifier is placed on each page such that the number of paragraphs read for each page may be entered into the box or checkable identifier. Additionally, a box or other checkable identifier is placed beside each paragraph. Once these steps are completed, the student is prepared to begin the assignment.

Once a particular paragraph has been read and fully understood, the box or other checkable identifier for that particular paragraph is checked, indicating that the paragraph has been read, fully understood, and checked, indication that all of the paragraphs of that page have been read and fully understood. Additionally, the total number of paragraphs read for the page is entered into the box or other checkable identifier on the page for the number of paragraphs read on that page.

It should be appreciated that these steps are repeated for each page of the assignment until each page of the assignment has been completed. In various exemplary embodiments, this procedure is used until a student has mastered the page of the assignment. When the student has mastered the paragraphs on the assignment, he/she is responsible only for checking off the pages of the assignment.

Once each page is completed, the student may optionally test his/her understanding of the page. This may be accomplished by asking classmates or a professor to quiz the student on the material that he/she is to have mastered. If the results of the quiz are acceptable, the student may continue reading. This exercise may be performed in the chat room of the web-based site or outside of the internet. If the student's performance is poor, the student must read the assignment again and get help with his/her understanding of the material. The internet provides these explanations or suggestions to those students on the internet. Moving forward without a proper understanding of the material results in wasted hours of study.

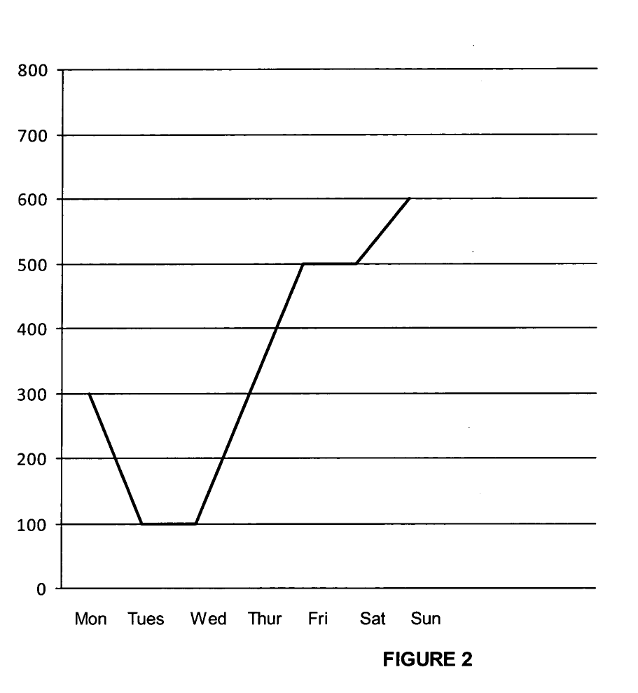

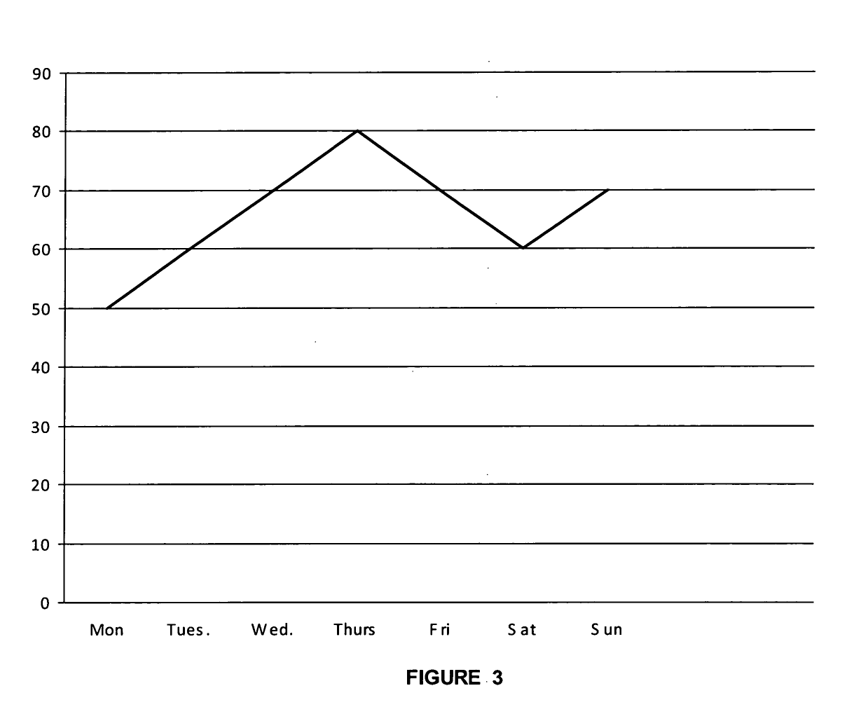

Using the internet web-based or notebook system and methods of this invention, the student keeps track of the total number of paragraphs read and pages read. In various exemplary embodiments, this is accomplished by placing the total number of paragraphs and/or pages read on the text of the material. In various other exemplary embodiments, the total number of paragraphs and pages read is tracked by the internet-based website that displays a page that exhibits a graph, such as for example the graphs shown in FIGS. 2 and 3.

As shown in FIG. 2, the exemplary graph 200 identifies the number of assigned paragraphs that a student has completed in a particular subject during each day of a given week. As shown in FIG. 2, the Y-axis (vertical) measures from 1-1000 paragraphs and the X-axis (horizontal) has the days of the week, Monday through Sunday. It should be appreciated that the number of paragraphs, as the number of pages, assignments, tests, exams, etc. is exemplary and should not be seen as limiting the present invention.

FIG. 3 shows an exemplary graph 300, which identifies the number of assigned paragraphs that a student has completed in a particular subject during each day of a given week. As shown in FIG. 3, the Y-axis (vertical) measures from 1-1000 pages and the X-axis (horizontal) has the days of the week, Monday through Sunday.

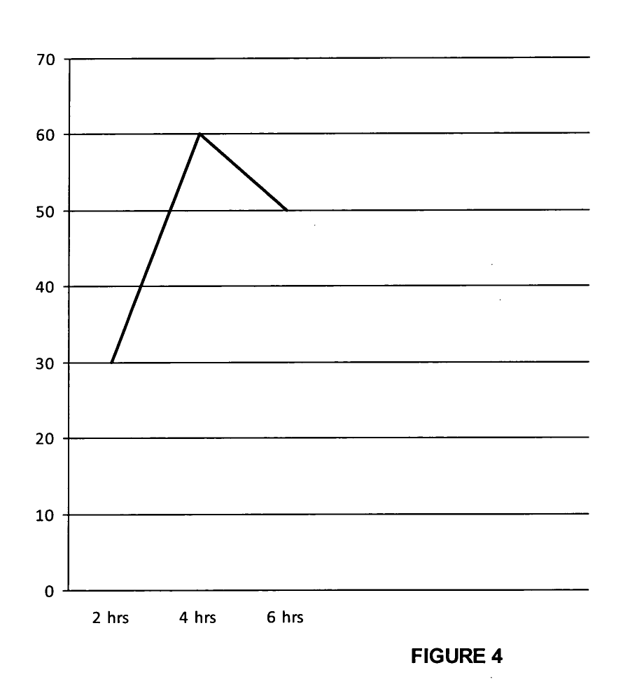

FIG. 4 shows an optional exemplary graph 400, which may be used to track the number of assigned pages that a student completes in a given time period. As shown in FIG. 4, the Y-axis (vertical) shows the total number of pages that a student has completed in a particular subject and the X-axis (horizontal) measures the hours.

By having the internet or the notebook chart the number of pages that a student can master in a given time period, the student is able to estimate how long it will take to complete future reading assignments. In this manner, the student is able to set goals that are achievable. Students should be advised to keep goals simple until they are able to accurately measure their reading comprehension level.

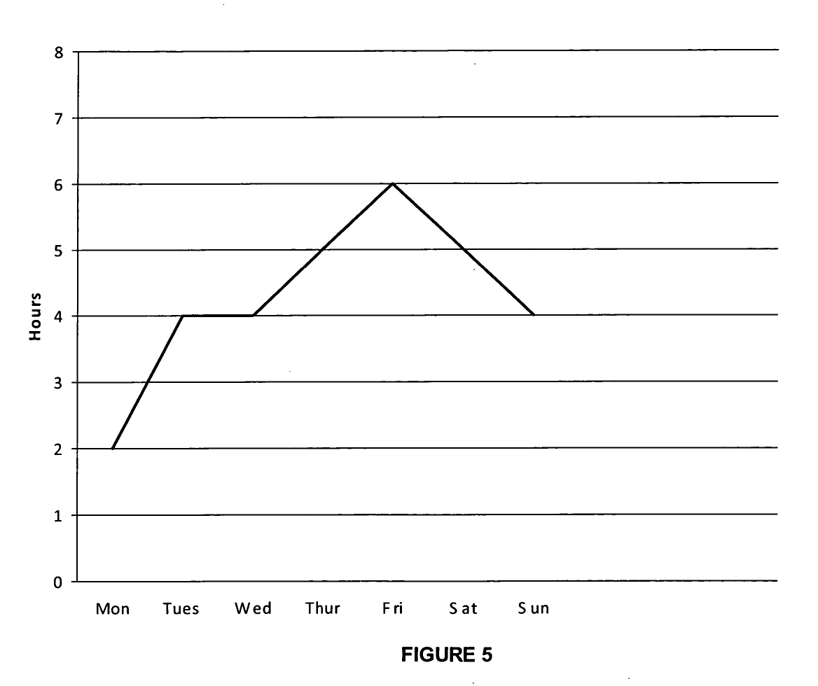

As shown in FIGS. 5-9, the internet system and methods of this invention utilize additional graphs that cover each of the areas the student must monitor, i.e., the number of hours studied per week per course, quiz scores, test scores, practice test scores, and completed homework assignment information for each class work course of study. The various graphs use the Y-axis (vertical) and the X-axis (horizontal) to measure the student's performance and/or performance indicators.

For example, as shown in FIG. 5, the exemplary graph 500 identifies the number of hours that a student studies in a particular subject during each day of a given week. As shown in FIG. 5, the Y-axis (vertical) shows the number of hours studied and the X-axis (horizontal) has the days of the week, Monday through Sunday.

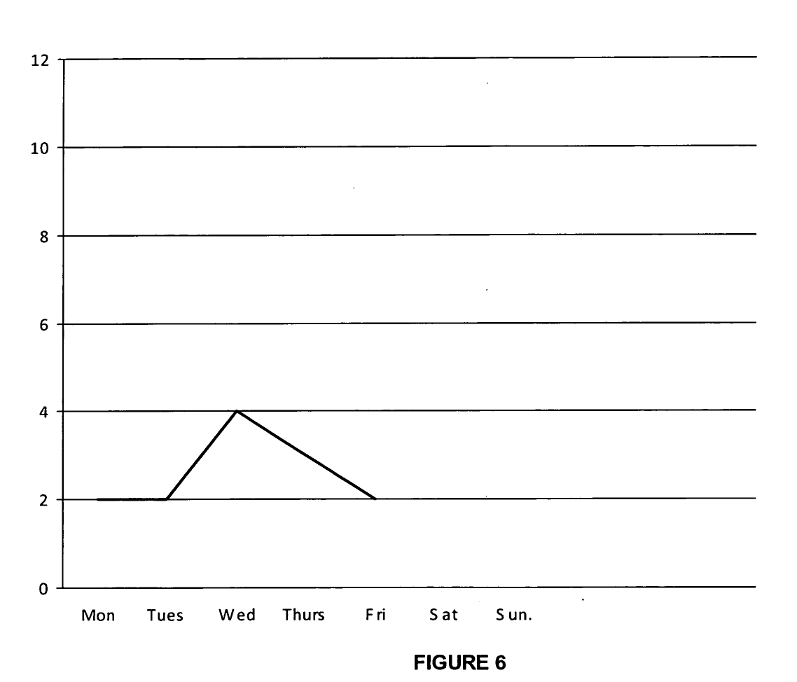

FIG. 6 shows an exemplary graph 600, which identifies the number of homework assignments completed before a given class for a given week on the Y-axis (vertical). As shown in FIG. 6, the X-axis (horizontal) has the days of the week, Monday through Sunday.

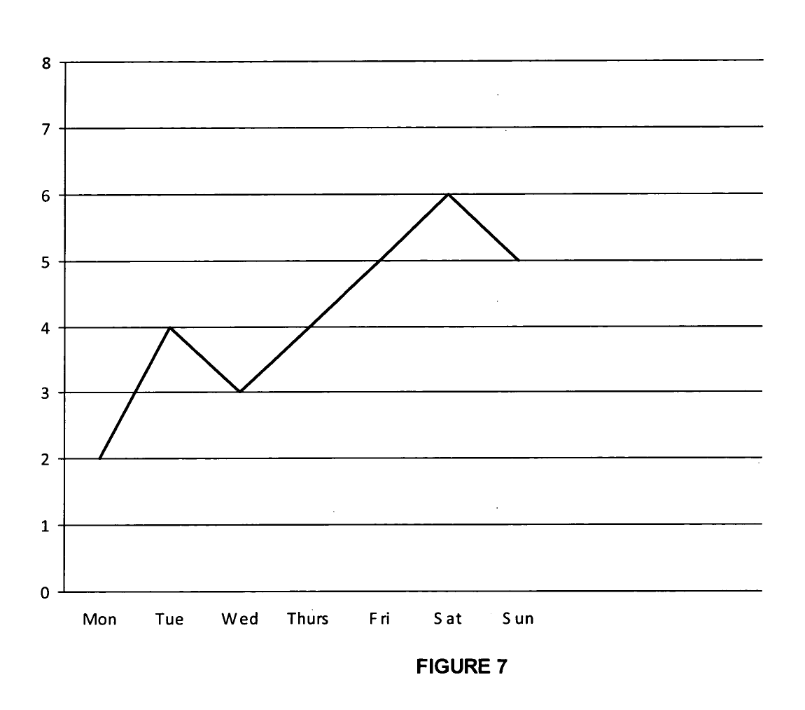

FIG. 7 shows an exemplary graph 700, which identifies the number of practice tests taken by a student during each day of a given week. As shown in FIG. 7, the Y-axis (vertical) shows the number of total practice tests for the subject and the X-axis (horizontal) has the days of the week, Monday through Sunday.

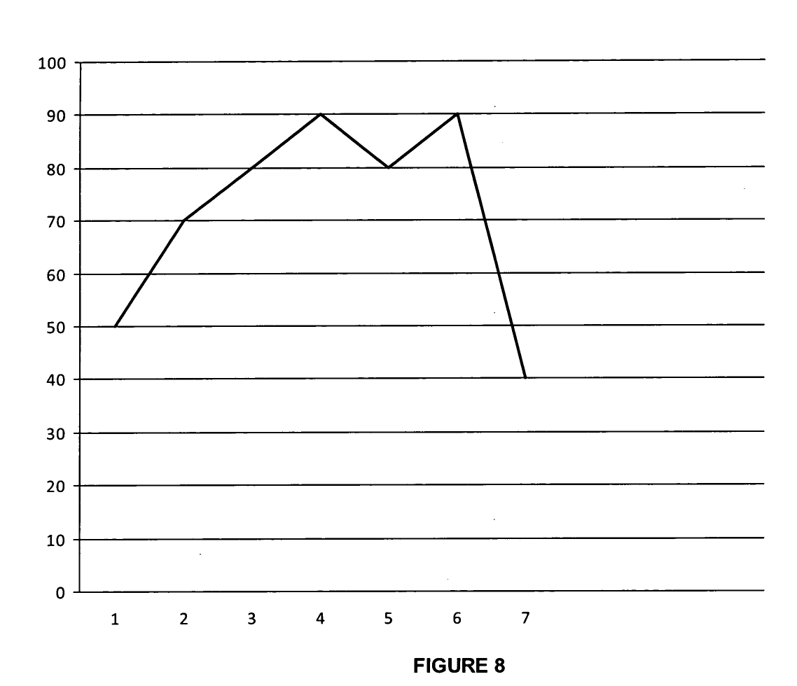

FIG. 8 shows an exemplary graph 800 outlining a student's score on certain examinations or tests given in any particular subject. As shown in FIG. 8, the Y-axis (vertical) is measured from 0-100 points, while the X-axis (horizontal) has a designation for each exam or test taken. These are official tests given by the instructor and are used to determine an official grade.

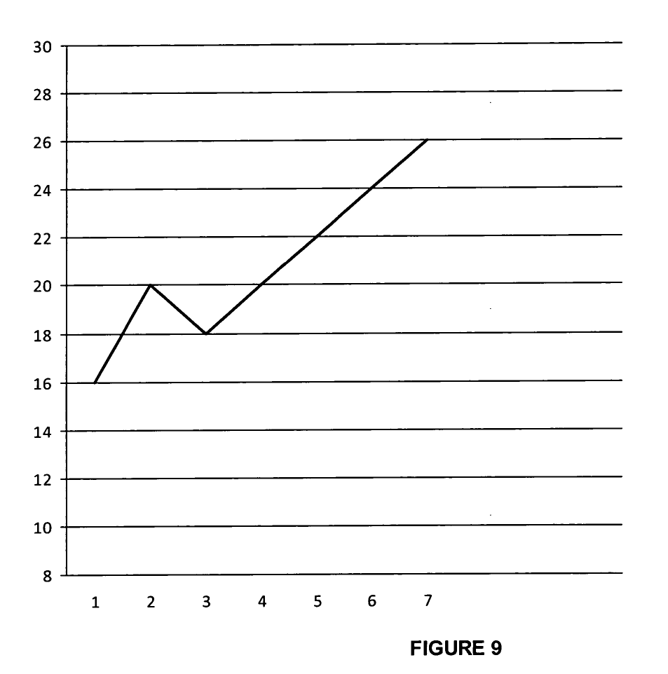

Finally, FIG. 9 shows an exemplary graph 900, which outlines the student's score for monthly practice standardized practice exams that are given. As shown in FIG. 9, the Y-axis (vertical) measures the number of points possible for the monthly standardized exam, while the X-axis (horizontal) has a designation for each exam or test taken.

By placing the KPI on the graph with colorful graphics and a speedometer to measure progress, it can readily be determined whether a student's weekly or periodic performance is improving, leveling off, or descending. The interpretation of a student's KPI is important to improve the student's performance. By utilizing the KPI graphs of the present invention, a student's performance may be evaluated and areas needing attention may be readily determined.

The recommendations for this are based on the graph. Once the KPI graphs are interpreted, a series of suggestions may be recommended to a student based on the performance of the KPI. If the graphs are not performing, suggestions to improve performance may range from increasing hours of study to increasing the number of practice tests per week.

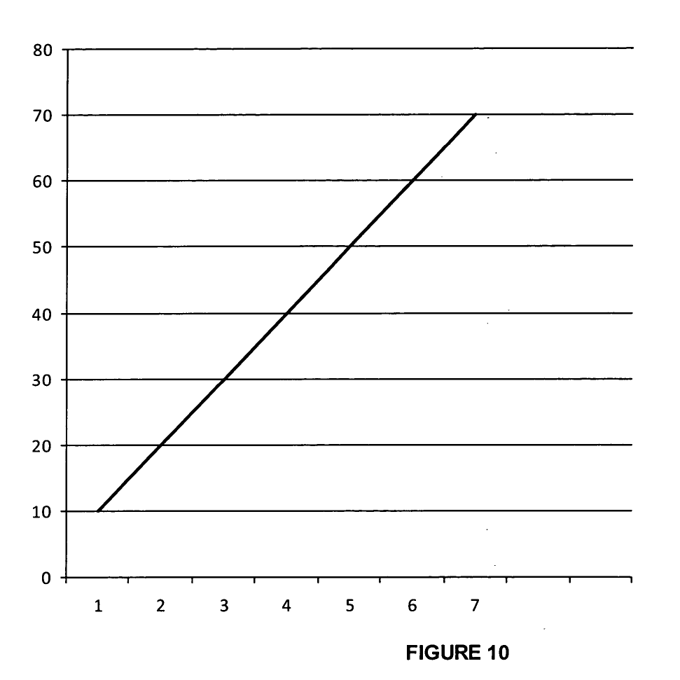

FIGS. 10-12 provide an example of how a student's performance may be evaluated by the KPI graphs. As shown in FIG. 10, an upward trend on the KPI graph is indicative of ascending, or improving, performance. A suggested recommendation when performance is improving is for the student to continue the recommended study schedule. Minor changes in study may be suggested to further improve performance. However, this may be a pseudo graph. If any changes are made with test taking skills or studying, outcomes must be monitored on a continuing basis.

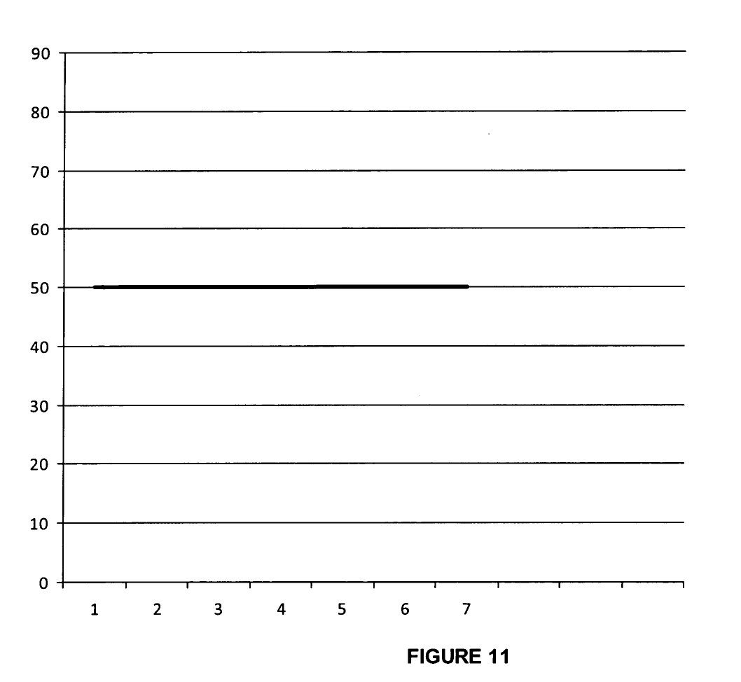

As shown in FIG. 11, a horizontal trend on a KPI graph is indicative of stagnant performance. When performance is stagnant, a student is no longer improving. A suggested recommendation when performance is stagnant is for the student to try a different study method. Perhaps determining the type of questions giving the student difficulty or using diagnostic test materials to determine the student's weakness can be used to begin a strategy to address the student's weakness. A close review of the student's studying and continued monitoring of the student's situation may also be recommended.

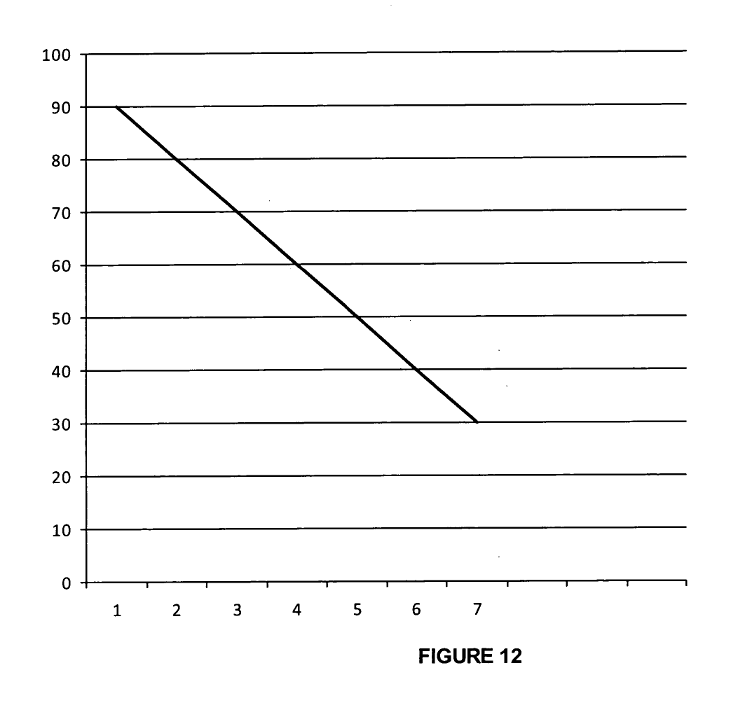

Finally, as shown in FIG. 12, a downward trend on a KPI graph is indicative of consistently poor performance. A suggested recommendation when performance is poor may be to consider whether a given course of study or program is suited for the student. Advice of an instructor should be sought and focus should be maintained upon accurately maintaining the student's KPI data. Emergency study and the use of diagnostic testing materials should be recommended to address the student's academic weakness.

While this invention has been described in conjunction with the exemplary embodiments and methods outlined above, it is evident that many alternatives, modifications, and variations will be apparent to those skilled in the art. Such adaptations and modifications should be and are intended to be comprehended within the meaning and range of equivalents of the disclosed exemplary embodiments. It is to be understood that the phraseology of terminology employed herein is for the purpose of description of the exemplary embodiments of the invention, as set forth above, are intended to be illustrative, not limiting. The foregoing is considered as illustrative only of the principles of the invention. Further, since numerous modifications and changes will readily occur to those skilled in the art, it is not designed to limit the invention to the exact construction and operation shown and described and, accordingly, all suitable modifications and equivalents may be resorted to, falling within the scope of the invention. Many improvements, modifications, and additions will be apparent to the skilled artisan without departing from the spirit and scope of the present invention as described herein and defined in the following claims.

What is claimed is:

1. A method for monitoring and promoting improvement in the performance of an activity by an individual, comprising:
developing at least one key performance indicator to measure the performance of the activity;
the individual performing each of the at least one key performance indicators;
tracking each of the at least one key performance indicators;
testing the performance of the activity at a desired interval to provide a plurality of test scores;
tracking the test scores; and
comparing the tracked test scores and the tracked key performance indicators and providing feedback to the individual such that an improvement in test scores indicates the individual is performing well and a decline in test scores indicates the individual is performing poorly.

2. The method as defined in claim 1, wherein the individual is a student in an academic environment.

3. The method as defined in claim 1, wherein the individual is a trainee in a training environment.

4. The method as defined in claim 1, wherein the individual is a business entity.

5. The method as defined in claim 1, in which each of the key performance indicators and the test scores are tracked by means of a computer network.

6. The method as defined in claim 2, further comprising the steps of:
providing access to the tracked key performance indicators and the tracked test scores to monitoring personnel for monitoring purposes.

7. The method as defined in claim 1, wherein, upon declining test scores, the feedback provided to the individual suggests steps for improving performance of the key performance indicators such that test scores are improved.

8. A method for monitoring and promoting improvement in the performance of an academic activity by an individual, comprising:
developing a plurality of key performance indicators to measure the performance of the academic activity;
the individual performing each of the key performance indicators;
tracking each of the key performance indicators;
testing the academic activity at a plurality of desired intervals to provide a plurality of test scores;
tracking the test scores; and
comparing the tracked test scores and the tracked key performance indicators and providing feedback to the individual such that an improvement in test scores indicates the individual is performing well and a decline in test scores indicates the individual is performing poorly.

9. The method of claim 8 in which one of the key performance indicators is the amount of academic reading completed in a set amount of time.

10. The method as defined in claim 8, in which one of the key performance indicators is the number of hours the individual spends studying academic materials in a set amount of time.

11. The method as defined in claim 8, in which each of the key performance indicators and the test scores are tracked by means of a computer network.

12. The method as defined in claim 11, further comprising the steps of:
providing access to the tracked key performance indicators and the tracked test scores to academic professionals for monitoring purposes.

13. The method as defined in claim 8, wherein, upon declining test scores, the feedback provided to the individual suggests steps for improving performance of the key performance indicators such that test scores are improved.

14. The method as defined in claim 8, wherein the key performance indicators comprise:
the number of hours studied in a set amount of time;
the number of pages read in a set assignment;
the number of paragraphs read in a set assignment;
practice tests covering the pages read;
performance on course examinations, quizzes and assignments;
the portion of course assignments completed;
the number of pages read and comprehended in a set amount of time;
the number of practice tests completed set amount of time; and
performance on practice standardized tests.
